(19) United States
(12) Patent Application Publication
(10) Pub. No.: US 2017/0096062 A1
(43) Pub. Date: Apr. 6, 2017

(54) Self-steering Four-wheel Drive Vehicle Chassis

(71) Applicants: Haotian Wu, Ann Arbor, MI (US); Cong Liao, West Lafayette, IN (US)

(72) Inventors: Haotian Wu, Ann Arbor, MI (US); Cong Liao, West Lafayette, IN (US)

(21) Appl. No.: 14/874,436

(22) Filed: Oct. 4, 2015

(51) Int. Cl. B60K 17/34; B60K 17/356

(52) U.S. Cl. CPC B60K 17/358; B60K 17/356

(57) ABSTRACT

A chassis for a four-wheel drive vehicle is presented. The vehicle chassis has a front sub-chassis assembly, rear front sub-chassis assembly, front hinge assembly, rear hinge assembly, main chassis frame, an independent powertrain sub-assembly for each wheel and electronic control system. The sub-chassis assembly can rotate about the axis of the hinge assembly. Each powertrain sub-assembly is controlled by the electronic control system. With torque vectoring control of the electronic control system, various combinations of driving and braking torque of each wheel can be achieved. The front sub-chassis assembly and the rear sub-chassis assembly can therefore rotate in clockwise or counter clockwise, which make the vehicle steer or translate even without conventional steering mechanisms.

The chassis has the front and rear sub-frame assemblies that can rotate according to the torque distribution among four wheels. Each wheel is propelled by an powertrain unit. Powertrain assembly consists of four powertrain units. Each powertrain unit includes a motor, a gear box, a driving shaft and two universal joints. The torque distribution is controlled by an electronic control system. The vehicle equipped with the present invention can accordingly steer and can achieve better mobility and steering stability and smaller steering radius.

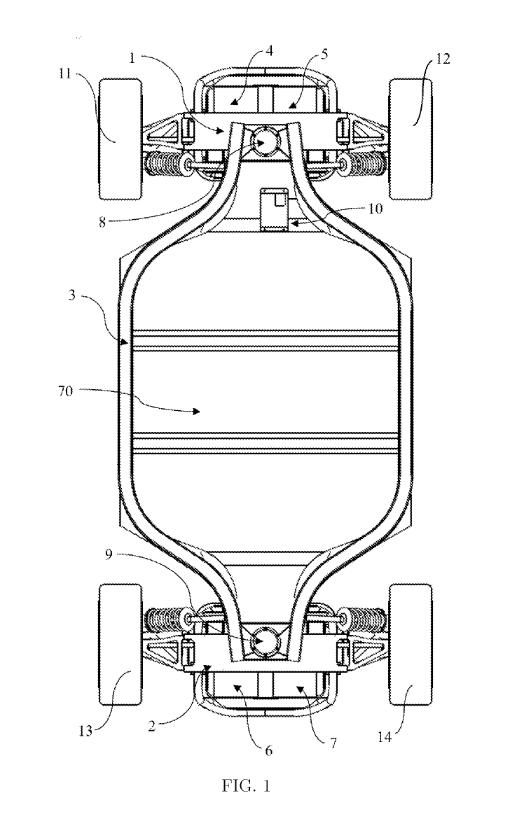

The paticular arrangement in FIG. 1 a chassis 70 for a four-wheel drive vehicle is shown. the chassis 70 includes a front sub-chassis assembly 1, a rear front sub-chassis assembly 2, a main chassis frame 3, a front left powertrain sub-assembly 4, a front right powertrain sub-assembly 5, a rear left powertrain sub-assembly 6, a rear right powertrain sub-assembly 7, a front hinge assembly 8, a rear hinge assembly 9 and an electronic control system 10. The front sub-chassis assembly 1 is hinged to the main chassis frame 3 through the front hinge assembly 8. The rear sub-chassis assembly 2 is hinged to the main chassis frame 3 through the rear hinge assembly 9. The front left powertrain sub-assembly 4, the front right powertrain sub-assembly 5, the rear left powertrain sub-assembly 6 and the rear right powertrain sub-assembly 7 are individually controlled by the electronic control unit 10 to provide independent driving torque to the front left wheel 11, the front right wheel 12, the rear left wheel 13 and the rear right wheel 14.

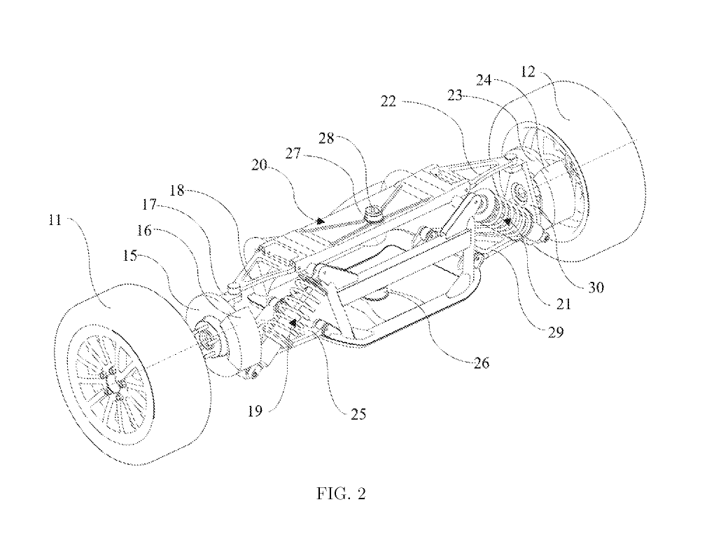

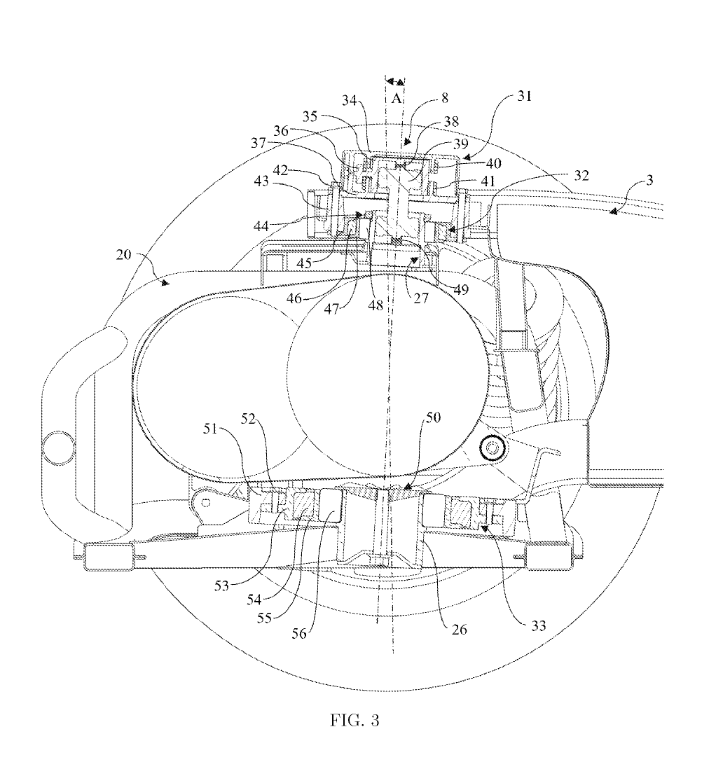

With particular reference to FIG. 2 of the drawings, the front sub-chassis assembly 1 is shown to include a front left rotor 15, a front left brake caliber 16, a front left knuckle 17, front left upper wishbone 18, a front left suspension 19, a front sub-frame 20, a front right suspension 21, a front right upper wishbone 22, a front right rotor 23, front right brake caliber 24, a front left lower wishbone 25, a lower hinge bearing shaft 26, a upper hinge bearing shaft 27, a connection rod socket 28, a front right lower wishbone 29 and a front left knuckle 30. The front left wheel 11 is bolted to front the left rotor 15 that is coupled to the front left knuckle 17 and has rotary freedom. The front left knuckle 17 is mounted to the far left ends of the front left upper wishbone 18 and the front left lower wishbone 25. The right ends of the front left upper wishbone 18 and the front left lower wishbone 25 are pivoted to the front sub-frame 20. The front left brake caliber 16 is mounted to the front left knuckle 17 and provides braking torque to the front left rotor 15. The lower end of the front left suspension 19 is pivoted to the front left knuckle 17. The upper end of the front left suspension 19 is pivoted to the front sub-frame 20. The lower hinge bearing shaft 26 and the upper hinge bearing shaft 27 are attached to the front sub-frame 20. The upper hinge bearing shaft 27 has the connection rod socket 28 that is coupled with a connection rod 39 in FIG. 3. The right hand of the front sub-frame 20 is the mirrored configuration to the left hand. The rear sub-chassis assembly 2 has the identical configuration and design with the front sub-chassis assembly 1.

With particular reference to FIG. 3 of the drawings, one sees the front hinge assembly 8 includes a returning device 31, a upper hinge bearing sub-assembly 32 and a lower hinge bearing sub-assembly 33. The returning device 31 consists of a returning device cap 34, a rod cup 35, a spring rock arm 36, a returning device base 37, a upper positioning spring 38, a connection rod 39, a clockwise return spring 40 and a counter clockwise return spring 41. The returning device cap 34 protects other parts from contamination and provides the support and stop for the clockwise return spring 40. The returning device base 37 provides the support and stop for the counter the clockwise return spring 41. Both the returning device cap 34 and returning device base 37 are bolted to the upper hinge mount 43 that is attached to the main chassis frame 3. The spring rock arm 36 is welded to the rod cup 35. The rod cup 35 is coupled with the connection rod 39 and can rotate in clockwise or counter clockwise direction. The clockwise return spring 40 or counter clockwise return spring 41 is pushed by the spring rock arm 36, which therefore generates returning torque. The upper positioning spring 38 prevents the connection rod 39 significant upward motion. The upper hinge bearing sub-assembly 32 consists of a upper thrust washer 44, upper outer cushion cup 45, a upper rubber cushion 46, a upper inner cushion cup 47 and a upper bearing 48. The upper thrust washer 44 positions the upper bearing 48 on the upper hinge bearing shaft 27. The inner ring of the upper bearing 48 is assembled to the upper hinge bearing 27 by shrink fitting or press fitting and can rotated with the upper hinge bearing 27. The outer ring of the upper bearing 48 is tightly mated with the upper inner cushion cup 47. The upper rubber cushion 46 is embedded between the upper inner cushion cup 47 and upper outer cushion cup 45. The upper outer cushion cup 45 has flange that can be bolted to the upper hinge mount 43. The lower hinge bearing sub-assembly 33 consists of a lower thrust washer 50, lower threaded fastener 51, lower hinge mount textbf52, lower outer cushion cup 53, lower rubber cushion 54, lower inner cushion cup 55 and lower bearing 56. The lower hinge bearing sub-assembly 33 has the identical configuration as upper hinge bearing sub-assembly 32 except the larger bore size of the lower bearing 56. The rear hinge assembly 9 has the identical configuration and design as the front hinge assembly 8.

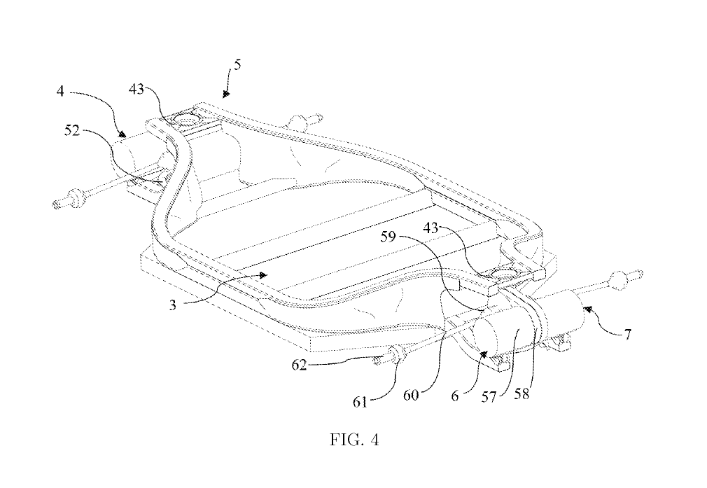

In FIG. 4, one sees a main chassis frame 3. The front end and the rear end of the main chassis frame 3 have a upper hinge mount 43 and a lower hinge mount 52. Both all hinge mounts yoke have machined mounting surfaces and bolt holes. The main chassis frame 3 also provides space and supports to energy reservoirs such as battery pack, fuel tank and hydraulic accumulator so on. The rear left powertrain sub-assembly 6 consists of a motor device 57, gearbox 58, propel shaft universe joint 59, propel shaft 60, wheel stub universe joint 61 and wheel stub 62. The motor device 57 could be a electric motor, internal combustion engine or hydraulic motor that can provide driving power. Driving power from the motor device 57 is transmitted through the gearbox 58, propel shaft universe joint 59, propel shaft 60, wheel stub universe joint 61 and wheel stub 62 to the driving wheel. The front left powertrain sub-assembly 4, front right powertrain sub-assembly 5 and rear right powertrain sub-assembly 7 have the identical configuration and design as the rear left powertrain sub-assembly 6. Therefore, each driving wheel has independent driving torque output.

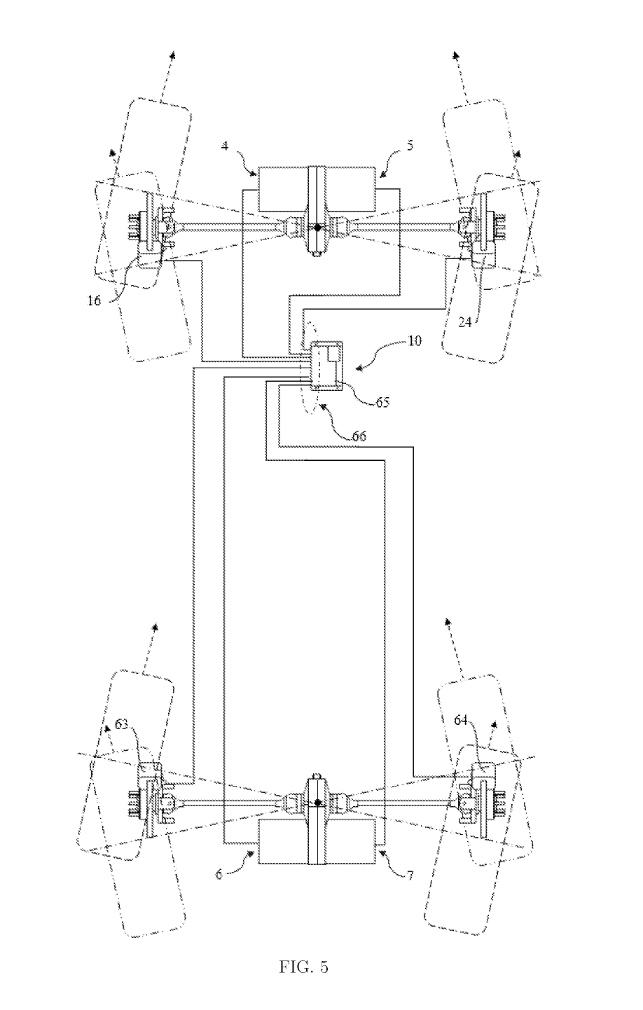

The paticular arrangement in FIG. 5 is shown that the electronic control system 10 comprises an electronic control unit 65 and wire harnesses 66. The electronic control unit 65 independently controls motors of the front left powertrain sub-assembly 4, front right powertrain sub-assembly 5, rear left powertrain sub-assembly 6 and rear right powertrain sub-assembly 7 to provide required torque. The electronic control system 10 also controls the front left brake caliber 16, front left brake caliber 24, rear left brake caliber 63 and front left brake caliber 64 to provide demanded braking torque. The wire harnesses 66 transmit control signals of the electronic control unit 65. With torque vectoring control of the electronic control system 10, various combinations of driving and braking torque at each wheel can be achieved. The front sub-chassis assembly 1 and the rear sub-chassis assembly 2 can therefore rotate in clockwise or counter clockwise direction, which make the vehicle implement cornering or translating.

A preferred embodiment of the invention has been disclosed to provide an understanding of the best applicability currently contemplated for the operation and construction of the four-wheel drive vehicle chassis. The invention being thus described are for purposes of illustration only since various changes and modifications without departing from the scope and true spirit of this invention will become apparent to those skilled in the art, are intended to be included within the scope of the following claims.

It is also to be understood that the following claims are intended to cover all of the generic and specific features of the invention herein described and all statements of the scope of the invention which, as a matter of language, might be said to fall there between.

What is claimed:

1. A chassis for use in a four-wheel drive vehicle having four independent power-train assemblies and front and rear sub-chassis assemblies, the chassis comprising:
A front sub-chassis assembly and a rear sub-chassis assembly are respectively articualted to a main chassis frame through a front hinge assembly and a rear hinge assembly, wherein the front sub-chassis assembly and the rear sub-chassis assembly are rotatable about the axis of the front hinge assembly and the axis of the rear hinge assembly;
The main chassis frame has mounts for hinge assemblies and the powertrain assembly, and wherein
The powertrain assembly has four sub-assemblies that are under control of a electronic control unit to provide independent driving torque to each wheel; the front sub-chassis assembly and the rear sub-chassis assembly rotate in clockwise or counter clockwise direction according to the combination of driving torque of each wheel.

2. The front sub-chassis assembly and the rear sub-chassis assembly of claim 1 comprise a sub-frame, a lower hinge bearing shaft and a upper hinge bearing shaft, and wherein the sub-frame supports brakes, suspensions and wishbone arms; the upper hinge bearing shaft includes a connection rod socket.

3. The front hinge assembly and the rear hinge assembly of claim 1 further comprise a returning device, a upper hinge-bearing sub-assembly and a lower hinge bearing sub-assembly, and in the vertical plane, the axis of hinge assemblies has a small angle against vertical direction.

4. The returning device of claim 3 further comprises returning springs, a rod cup, a spring rock arm and a connection rod, and wherein the connection rod transmits returning torque of returning springs to the sub-chassis assembly.

5. The lower hinge sub-assembly and the upper hinge sub-assembly of claim 3 further comprising a, bearing, an inner cushion cup, a rubber cushion and an outer cushion cup.

6. The powertrain sub-assemblies of claim 1 further comprising a motor device, a gearbox, a driving shaft and two universal joints, wherein the driving shaft, the gearbox and universal joints are used to transfer the power of the motor device to a driving wheel.

7. The electronic control system of claim 1 further comprising an electronic control unit and wire harnesses, wherein the electronic control unit independently controls torque output of each powertrain sub-assembly and each brake caliber to make a vehicle implement cornering or translating.
